(19) United States
(12) Patent Application Publication
(10) Pub. No.: US 2020/0142439 A1
(43) Pub. Date: May 7, 2020

(54) ROTARY CONTROL DEVICE

(71) Applicant: ZF Friedrichshafen AG, Friedrichshafen (DE)

(72) Inventors: Rainer Haevescher, Stemwede (DE); Artur Neumann, Kalletal (DE)

(73) Assignee: ZF Friedrichshafen AG, Friedrichshafen (DE)

(21) Appl. No.: 16/624,241

(22) PCT Filed: May 23, 2018
(86) PCT No.: PCT/EP2018/063538

§ 371 Date: Dec. 18, 2019

(30) Foreign Application Priority Data
Jun. 21, 2017 (DE) 10 2017 210 436.8

(51) Int. Cl. G05G 5/03; F16H 48/34; B60K 37/06; F16H 63/30; H01H 3/08

(52) U.S. Cl. CPC G05G 5/03; F16H 48/34; B60K 37/06; H01H 2003/008; H01H 3/08; F16H 2048/343; B60K 2370/158; F16H 63/304

(57) ABSTRACT

The invention relates to a rotary control device (1) for a vehicle comprising a user interface surface (3), in particular a knob, that is embodied to rotate with respect to a housing (5) of the device (1) around a rotational axis (7) of the device (1), further comprising a sensor unit (9) for monitoring the orientation and/or rotational movement of the user interface surface (3) with respect to the housing (5), a processing unit (11), and a communications interface (13) for transmitting control signals (Ts) according to an output (Op) from the processing unit (11), said output (Op) being generated by the processing unit (11) on the basis of sensor data (Ds) from the sensor unit (9).

The invention relates to a rotary control device for a vehicle comprising a user interface surface that is embodied to rotate with respect to a housing of the device around a rotational axis of the device, further comprising a sensor unit for monitoring the orientation and/or rotational movement of the user interface surface with respect to the housing, a processing unit, and a communications interface for transmitting control signals according to an output from the processing unit, said output being generated by the processing unit on the basis of sensor data from the sensor unit, wherein the rotary control device further comprises a magnetorheological actuator, wherein the magnetorheological actuator comprises a rotational element that is mechanically connected to the user interface surface and serves to interact with a magnetorheological fluid of the magnetorheological actuator, and wherein the magnetorheological actuator comprises an assembly for generating and/or manipulating properties of a magnetic field acting on the magnetorheological fluid such that the magnetorheological actuator serves to modulate torque transmission between the user interface surface and the housing.

Haptic interfaces for control are known for example from the European patent publication EP2065614A1, wherein an assembly for manipulating properties of a magnetic field is disclosed for the purpose of modulating the torque transfer between a rotational element and a housing of the haptic interface.

Such control devices based on magnetorheological actuators are capable of making selections and issuing control signals in a great variety of ways. However, in some control applications, especially in a vehicle where operational modes can be selected with such a device, there is need to restrict the selection capabilities of the device in order to prevent a user from entering commands which can be destructive for the system or machine being controlled. In vehicles the lack of such restrictions can even lead to life threatening situations.

The object of the invention is therefore to introduce a rotary control device that can be operated more safely.

The object of the invention is achieved by a rotary control device defined by the subject matter of the independent claim. The dependent claims and the description define advantageous embodiments of the system.

The object is therefore achieved by a rotary control device for a vehicle comprising a user interface surface that is embodied to rotate with respect to a housing of the device around a rotational axis of the device, further comprising a sensor unit for monitoring the orientation and/or rotational movement of the user interface surface with respect to the housing, a processing unit, and a communications interface for transmitting control signals according to an output from the processing unit, said output being generated by the processing unit on the basis of sensor data from the sensor unit, wherein the rotary control device further comprises a magnetorheological actuator, wherein the magnetorheological actuator comprises a rotational element that is mechanically connected to the user interface surface and serves to interact with a magnetorheological fluid of the magnetorheological actuator, and wherein the magnetorheological actuator comprises an assembly for generating and/or manipulating properties of a magnetic field acting on the magnetorheological fluid such that the magnetorheological actuator serves to modulate torque transmission between the user interface surface and the housing, wherein the actuator is embodied to generate and/or manipulate the properties of the magnetic field according to vehicle status signals received by the device via the communications interface and on the basis of the sensor data from the sensor unit that indicates a current orientation of the user interfaced surface and/or a rotational movement of the user interface surface from a first orientation to a second orientation.

A vehicle status signal can, for example, contain information regarding the speed and operational mode of the vehicle. When a street vehicle with a transmission module for transferring torque from a drive unit of the vehicle along the drive chain to wheels of a vehicle is traveling at high speed in a forward direction, it would be devastating for the transmission module if an operational mode for driving in a reverse direction was implemented. The rotary control device according can therefore accordingly take into account such information when governing the MRF actuator. Advantageously, with rotary control device as defined above, an operator, or user, of the vehicle is cannot rotate the user interface surface to an orientation for selecting a reverse operation mode in this situation.

A position of the user interface surface in the sense of the invention refers to the placement of the user interface surface within a plane spatially displaced from the housing of the device by a specified distance. An orientation of the user interface surface in the sense of the invention refers to a rotational displacement of the user interface surface around the rotational axis of the device by a specific degree of rotation with respect to an initial setting of the user interface surface with reference to the housing.

The magneto-rheological fluid defines the behavior of the rotary control device. To this end, a voltage supplied to the assembly is varied to induce a surrounding magnetic field that changes the viscosity of the fluid. Depending on the magnetic field, in particular depending on properties of the magnetic field such as intensity and/or direction, the MRF can vary between liquid and solid state, which can be controlled very accurately. In a fluid state, MRF transfers little to no torque between the rotational element and the housing. However, as the viscosity increases and the fluid approaches a solid state, the sheer forces within the fluid and between the fluid and the rotational element as well as between the fluid and the housing, or a component attached fixedly to the housing, increases. This leads to an increasing torque transfer between the user interface surface and the housing.

The device can be used to select an operation mode of the vehicle, which is for example a forwards drive operation mode wherein torque is transferred from a drive unit of the vehicle in order to propel the vehicle in a forwards direction, a reverse drive operation mode wherein torque is transferred from a drive unit of the vehicle in order to propel the vehicle in a reverse direction, a neutral operation mode wherein no torque is transferred from a drive unit of the vehicle, a park operation mode where a torque transmission unit attached to the drive unit of the vehicle is mechanically blocked, or another operation mode.

When a position and/or orientation of the user interface surface remains constant in the absence of a force applied the device from an external source, then this position and/or orientation of the user interface surface can be referred to as a stable position. On the other hand, when the user interface surface does not remain in a certain position or orientation, because for example a mechanism of the device applies a force internally, then this position and/or orientation can be referred to as being non-stable.

A safety relevant function of the vehicle in the sense of the invention can be for example the selection of an operation mode of the vehicle, steering, accelerating or braking the vehicle. A non-safety function of the vehicle can be for example navigation or control of a multimedia interface.

A communications pathway in the sense of the invention can be for example a hardline for transferring data such as a databus and/or a wireless data transmission channel. In many modern street vehicles, a CAN-databus is a preferred type of communications pathway.

The user interface surface, or knob, in the sense of the invention can comprise the outer surface of a ring shaped and/or half shell shaped structure, which is accessible to an operator, i.e. user, of the vehicle. The user interface surface can further comprise a construction underlying the outer surface of the user interface surface.

In an embodiment of the inventive rotary control device the device is embodied to such that when the vehicle status signals are received via the communications interface they are diverted to the processing unit, and in that the processing unit is embodied to carry out a comparison of the information contained in the vehicle status signals with a set of predetermined values of parameters stored in a memory unit of the device, and in that when the processing unit is embodied to output governing signals to the assembly according to the results of the comparison.

In an embodiment of the inventive rotary control device the processing unit is embodied to compare information comprised in a vehicle status signal indicating a current velocity value of the vehicle with a predetermined value of a velocity threshold parameter stored in a memory of the device, and in that when the velocity value exceeds the threshold value the processing unit is embodied to output governing signals to assembly such that the assembly manipulates the properties of the magnetic field such that a rotation of the user surface interface from the first orientation to the second orientation is inhibited.

In an embodiment of the inventive rotary control device the processing unit is embodied to output governing signals to assembly such that the assembly manipulates the properties of the magnetic field such that a rotation of the user surface interface from the first orientation to the second orientation is inhibited based on a current orientation of the user interface surface.

In an embodiment of the inventive rotary control device the processing unit is embodied to output governing signals to assembly such that the assembly manipulates the properties of the magnetic field such that a rotation of the user surface interface from the first orientation to the second orientation is inhibited based on a current operation mode of the vehicle.

In an embodiment of the inventive rotary control device the processing unit is embodied to output governing signals to assembly such that the assembly manipulates the properties of the magnetic field such that a rotation of the user surface interface from the first orientation to the second orientation is inhibited based on data stored in a memory of the device regarding the control signal transmitted from the communications interface immediately previously.

In an embodiment of the inventive rotary control device the device is embodied transmit control signals for selecting operation modes of the vehicle.

In an embodiment of the inventive rotary control device, when the device receives a vehicle status signal indicating that the vehicle is traveling with a speed above a predetermined speed threshold in a forwards direction, in particular when the vehicle is in a forwards drive operation mode, that the processing unit outputs governing signals to the assembly to inhibit the user interface surface from being rotated to a second orientation for selecting a reverse drive operation mode and/or in that the processing unit actively disregards sensor data indicating that the user interface surface has, despite the inhibition provided via the actuator, been rotated to an orientation for selecting a reverse operation mode.

In an embodiment of the inventive rotary control device, when the device receives a vehicle status signal indicating that the vehicle is traveling with a speed above a predetermined speed threshold in a reverse direction, in particular when the vehicle is in a reverse drive operation mode, that the processing unit outputs governing signals to the assembly to inhibit the user interface surface from being rotated to an orientation for selecting a forward drive operation mode and/or in that the processing unit actively disregards sensor data indicating that the user interface surface has, despite the inhibition provided via the actuator, been rotated to an orientation for selecting a forwards operation mode.

An embodiment of the invention will next be explained in detail with reference to the following FIGURE. It shows:

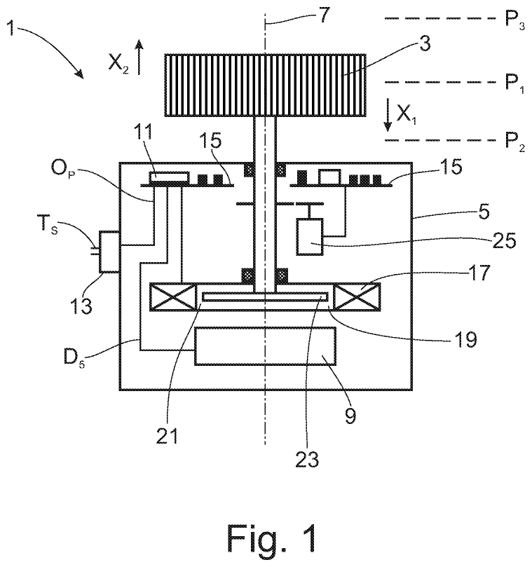

FIG. 1 a schematic diagram of an embodiment of the inventive rotary control device.

FIG. 1 shows a schematic diagram of an embodiment of the inventive rotary control device 1 having a user interface surface 3, which can be moved and rotated by a user or operator of a vehicle. The user interface surface can be rotated around a rotational axis 7 of the device 1 to various orientations, for example for selecting operation modes of a vehicle. The user interface surface 3 can furthermore be moved by a user or operator of the vehicle between a first, second and third position P1, P2, P3.

The device 1 comprises a housing 5, which at least partially encloses a processing unit 11 mounted on a substrate 15, which is a printed circuit board. The processing unit 11 is connected to a communications interface 13. Via the communications interface 13 signals such as control signals Ts can be transmitted and received.

In particular, the communications interface 13 is can receive vehicle status signals. The vehicle status signals can be forwarded to the processing unit 11, where the information contained in these signals can be taken into account when issuing governing signals for controlling the behavior of the assembly.

The processing unit 11 is further connected to a sensor unit 9 which serves to monitor the rotational movement and/or orientation of the user interface surface with respect to the housing 5. The sensor unit 9 transmits sensor data Ds to the processing unit 11 and on the basis of this sensor data Ds, the processing unit 11 can generate control signals to transmit via the communications interface 13.

The device further comprises an assembly 17 for generating and manipulating a magnetic field in a chamber 19 of the housing 5. The chamber contains a magnetorheological fluid 21 also known as MRF. Positioned partially within the chamber is a rotational element 23. The rotational element 23 is mechanically connected to the user interface surface 3 and rotates with the rotation of the interface 3.

Corresponding to changes in properties of the magnetic field caused by the assembly 17, such as field strength and direction, the magnetorheological fluid 12 varies in viscosity so to speak. Therefore, in a corresponding way, the fluid transfers more or less torque between the user interface surface 3 and the housing 5 of the device 1. This is due to the changing sheer forces within the fluid and between the fluid and the chamber wall. Since the housing 5 of the device is generally fixedly mounted within the vehicle, the assembly can be considered to modulate a sort of braking force acting on the user interface surface 3. Such systems comprising MRF 21 in a chamber 19, rotational elements 23, and assemblies 17 for manipulating the magnetic field within the chamber 19 are often referred to as MRF-Actuators. The processing unit 11 is embodied to output governing signals for controlling the assembly 17. The assembly 17 can, for example, be driven by a circuit on the substrate 15 feeding the assembly 17 with a pulsed width modulated (PWM) current or voltage in accordance with the governing signals from the processing unit 11.

The device further comprises a servo actuator 25 which engages with the rotational element 23 and can therefore apply torque to the user interface surface 3.

### REFERENCE CHARACTERS

1 Rotary control device
3 user interface surface
5 housing
7 rotational axis
9 sensor unit
11 processing unit
13 communications interface
15 substrate/PCB
17 assembly for generating/manipulating magnetic field
19 chamber
21 magnetorheological fluid
23 rotational element
25 servo actuator
X1 first direction
X2 second direction
P1 first position
P2 second position
P3 third position

1. A rotary control device for a vehicle comprising:
a user interface surface configured to rotate with respect to a housing of the device around a rotational axis of the device;
a sensor unit configured to monitor at least one of an orientation or a rotational movement of the user interface surface with respect to the housing;
a processing unit configured to generate an output on a basis of sensor data from the sensor unit;
a communications interface configured to transmit control signals according to the output from the processing unit; and
a magnetorheological actuator comprising:
a rotational element that is mechanically connected to the user interface surface and serves to interact with a magnetorheological fluid of the magnetorheological actuator; and
an assembly configured to at least one of generate or manipulate properties of a magnetic field acting on the magnetorheological fluid such that the magnetorheological actuator serves to modulate torque transmission between the user interface surface and the housing according to vehicle status signals received by the device via the communications interface and on the basis of the sensor data from the sensor unit that indicates at least one of a current orientation of the user interface surface or a rotational movement of the user interface surface from a first orientation toward a second orientation.

2. The rotary control device according to claim 1, wherein the device is configured to divert the vehicle status signals received via the communications interface they are diverted to the processing unit;
wherein the processing unit is configured to compare information contained in the vehicle status signals with a set of predetermined values of parameters stored in a memory unit of the device, and output governing signals to the assembly according to results of the comparison.

3. The rotary control device according to claim 1, wherein the processing unit is configured to:
compare information comprised in at least one vehicle status signal of the vehicle status signals indicating a current velocity value of the vehicle with a predetermined value of a velocity threshold parameter stored in a memory of the device to determine that the velocity value exceeds the threshold value; and
responsively output governing signals to the assembly such that to cause the assembly to manipulate the properties of the magnetic field such that the rotational movement of the user surface interface from the first orientation to the second orientation is inhibited.

4. The rotary control device according to claim 1, wherein the processing unit is configured to output governing signals to the assembly to cause the assembly to manipulate the properties of the magnetic field such that the rotational movement of the user surface interface from the first orientation to the second orientation is inhibited based, at least in part, on a current orientation of the user interface surface.

5. The rotary control device according to claim 1, wherein the processing unit is configured to output governing signals to the assembly to cause the assembly to manipulate the properties of the magnetic field such that the rotational movement of the user surface interface from the first orientation to the second orientation is inhibited based, at least in part, on a current operation mode of the vehicle.

6. The rotary control device according to claim 1, wherein the processing unit is configured to output governing signals to the assembly to cause the assembly to manipulate the properties of the magnetic field such that the rotational movement of the user surface interface from the first orientation to the second orientation is inhibited based, at least in part, on data stored in a memory of the device regarding a last control signal transmitted from the communications interface.

7. The rotary control device according to claim 1, wherein the device is configured to transmit the control signals for selecting operation modes of the vehicle.

8. The rotary control device according to claim 1, wherein the communications interface is configured to receive a vehicle status signal indicating that the vehicle is traveling with a speed above a predetermined speed threshold in a forward direction;
and wherein the processing unit is configured to, in response to the communications interface receiving the vehicle status signal indicating that the vehicle is traveling with a speed above the predetermined speed threshold in the forward direction, output governing signals to the assembly to cause the assembly to inhibit the user interface surface from being rotated to the second orientation, wherein the second orientation is for selecting a reverse drive operation mode.

9. The rotary control device according to claim 1, wherein the communications interface is configured to receive a vehicle status signal indicating that the vehicle is traveling with a speed above a predetermined speed threshold in a reverse direction;
and wherein the processing unit is configured to, in response to the communications interface receiving the vehicle status signal indicating that the vehicle is traveling with a speed above the predetermined speed threshold in the reverse direction, output governing signals to the assembly to cause the assembly to inhibit the user interface surface from being rotated to the second orientation, wherein the second orientation is for selecting a forward drive operation mode.

10. The rotary control device according to claim 1, wherein the communications interface is configured to receive a vehicle status signal indicating that the vehicle is traveling with a speed above a predetermined speed threshold in a forward direction;
and wherein the processing unit is configured to, in response to the communications interface receiving the vehicle status signal indicating that the vehicle is traveling with a speed above the predetermined speed threshold in the forward direction, actively disregard sensor data indicating that the user interface surface has been rotated to the second orientation, wherein the second orientation is for selecting a reverse operation mode.

11. The rotary control device according to claim 1, wherein the communications interface is configured to receive a vehicle status signal indicating that the vehicle is traveling with a speed above a predetermined speed threshold in a reverse direction;
and wherein the processing unit is configured to, in response to the communications interface receiving the vehicle status signal indicating that the vehicle is traveling with a speed above the predetermined speed threshold in the reverse direction, actively disregard sensor data indicating that the user interface surface has been rotated to the second orientation, wherein the second orientation is for selecting a forward operation mode.
